(19) United States
(12) Patent Application Publication
(10) Pub. No.: US 2007/0055528 A1
(43) Pub. Date: Mar. 8, 2007

(54) Teaching aid and voice game system

(76) Inventor: Dmitry Malyshev, San Francisco, CA (US)

Correspondence Address: DMITRY MALYSHEV, Apt. A, 44 DORADO TERRACE, San Francisco, CA, 94112, US

(21) Appl. No.: 11/214,423

(22) Filed: Aug. 30, 2005

(51) Int. Cl. G10L 21/00

(52) U.S. Cl. 704/275

(57) ABSTRACT

A device of the invention is a simple, light-weight, universal, and portable voice activated teaching aid and/or game system that can be used by a person who for any reasons cannot distract his/her attention from a predetermined object, e.g., when fulfilling a long and monotonous work, or cannot use his/her vision or hands for any other reasons. The system consists of a central processing unit, a voice digitizer connected to a microphone and to said central processing unit, a system input port, a microphone connected to said voice digitizer, a memory buffer connected to said system input port and to said central processing unit, a speech synthesizer connected to the central processing unit; a loudspeaker connected to said speed synthesizer; and a counter connected to said central processing unit.

### FIELD OF THE INVENTION

The present invention relates to a teaching-aid device and/or a voice game, in particular to a voice game or voice-activated teaching aid that allows the user to play a game, learn a foreign language, or prepare himself/herself to a test, such as a multiple-choice exam test. The invention is particular suitable for cases when a person who is going to use the game fulfills a long and monotonous work that does not allow the use of hands or distract a vision attention. In particular, the invention relates to aforementioned devices that are self-contained, portable, and light in weight so that it can be used, e.g., by a person who uses the device while jogging, walking, or sitting in a car.

### BACKGROUND OF THE INVENTION

Voice games are known. For example, U.S. Pat. No. 6,210,278 issued in 2001 to D. Klistner discloses a hand-held voice game that includes a plurality of input devices, an audible output device, and a controller coupled to each of the input devices and to the audible output device. Preferably, each of the input devices requires a different mechanical action, such as that of a pressure switch, a pull switch or a rotational switch. The controller outputs a first command signal to the audible output device that relates to a first selected input device. The controller then outputs a second command signal to the audible output device relating to a second selected input device when the first selected input device is actuated within a predetermined period of time. When the first selected input device is not actuated within the predetermined period of time, or when an input device other than the selected input device is actuated in response to the first command signal, the controller outputs an error command signal to the audible output device. The controller then ceases to output command signals to the audible output device after outputting the error command signal. According to the invention, the second command can relate to a second selected input device or can be an audible indication, such as a voice message, for a user to pass the game apparatus to another user.

U.S. Pat. No. 6,471,420 issued in 2002 to H. Maekawa, et al. relates to a voice selection apparatus, voice response apparatus, and game apparatus using word tables from which selected words are output as voice selections. A game apparatus of the invention includes: a voice input section for inputting at least one voice set including voice uttered by an operator, for converting the voice set into a first electric signal, and for outputting the first electric signal; a voice recognition section for recognizing the voice set on the basis of the first electric signal output from the voice input means; an image input section for optically detecting a movement of the lips of the operator, for converting the detected movement of lips into a second electric signal, and for outputting the second electric signal; a speech period detection section for receiving the second electric signal, and for obtaining a period in which the voice is uttered by the operator on the basis of the received second electric signal; an overall judgment section for extracting the voice uttered by the operator from the input voice set, on the basis of the voice set recognized by the voice recognition means and the period obtained by the speech period detection means; and a control means for controlling an object on the basis of the voice extracted by the overall judgment means.

U.S. Pat. No. 6,500,006 issued in 2002 to C. Wakamoto describes a learning and entertainment device, method, and system and storage media thereof that allow the user, while watching the television screen, to speak-the part of the character which has been selectively turned off, and to check his pronunciation with the subtitle or voice playback simultaneously or successively, thus making it possible to learn a language enjoyably and effectively while at the same time watching attractive images and listening to music. The system, device and method allow pronunciation to be practiced effectively by selecting a first sound signal and a second sound signal from a first sound channel CH1 and a second sound channel CH2, turning at least one of the voices from one of the channels off, and processing this voice which has been turned off with the aid of mixers and a speaker with attached microphone.

U.S. Pat. No. 6,529,875 issued in 2003 to T. Nakajima, et al. discloses a voice recognizer, voice recognizing method, and game machine using them. The voice recognition device used as a peripheral device for a game machine including a voice input device, a voice recognition section for recognizing the player's voice by comparing the voice signal output from the voice input device with data from previously defined voice recognition dictionaries and generating control signals relating to the game on the basis of the recognition result. The voice recognition section includes a non-specific speaker voice recognition dictionary which is previously defined for unspecified speakers, and a specific speaker voice recognition dictionary which is defined by the player.

U.S. Pat. No. 6,554,707 issued in 2003 to M/ Sinclair, et al. describes a system and a method for providing an interface to and customizing an interactive application for one or more player. The interactive game of the presently preferred embodiment is played in a wireless environment using a mobile station as a user interface with commands entered via a keyboard or via voice. The game is tracked and controlled using a game center and a game server, which is typically at a location remote from the mobile station. Communication between the game server and the mobile station is typically performed using a base station connected to a telecommunications network. The game server executes a software application, which runs a game center. Individual games are managed within the context of this application.

US Patent Application Publication No. 20050102141 published in 2005 (inventor—T. Chikuri) describes a voice operation device that includes the following components: a voice recognition dictionary for storing plurality of groups of synonyms provided for plurality of functions of devices to be operated and each includes at least one word; voice recognition unit that checks voice data from voice taking unit against words stored in voice recognition dictionary to recognize word corresponding to voice; device control unit that controls devices to be operated based on word recognized by voice recognition unit; recognition history storage unit that sequentially stores words recognized by voice recognition unit; and dictionary update unit that updates voice recognition dictionary in such way that words which are determined to have been recognized at low frequencies in the past, based on recognition history stored in recognition history storage unit, are deleted except at least one of word which is left in each group of plurality of groups of synonyms in order to be checked.

The voice operation device of this invention can be used for operating a vehicle mounted device such as vehicle mounted audio device and air conditioning device. In this voice operation device, a device to be operated is designated by use of a manually operated switch or the like and this designated device to be operated is operated by use of voice. This voice operation device is provided with a plurality of voice recognition dictionaries which are respectively corresponding to a plurality of vehicle mounted devices, and the voice recognition dictionaries are switched according to the designated device to be operated. In the voice recognition dictionary, a plurality of words or synonyms is prepared for one function of each device to be operated. In the voice operation device like this, input voice is checked against the plurality of words in the voice recognition dictionary and a word that is the most similar to the input voice is adopted as an operation command for the device to be operated. In general, as words which are prepared for one function increase in number, a probability of hitting the function at the time of checking increases whereas the rate of voice recognition decreases. However, according to this voice operation device, in a case where a plurality of devices to be operated are operated by use of voice input, only a voice recognition dictionary corresponding to each device to be operated is made effective, so that words to be checked can be decreased in number. As a result, this can enhance the rate of voice recognition.

There is a plurality of voice-activated games and learning systems of different type, but a common disadvantage of all these devices is that they are either not portable, complicated in structure and use, or, if portable, are very specific, have limited capabilities, and low versatility. Furthermore, the known portable voice-operated game or teaching devices and systems do not have an option of using an enormous volume of information available on the Internet.

### SUMMARY OF THE INVENTION

It is an object of the present invention to provide a simple, light-weight, universal, and portable voice activated teaching aid and/or game that can be used by a person who for any reasons cannot distract his/her attention from a predetermined object, e.g., when fulfilling a long and monotonous work, or cannot use his/her vision or hands for any other reasons. It is another object to provide a voice-activated teaching or learning device or system or game that may be loaded with an enormous volume of information but requires only a very small amount of machine-recognizable words or commands pronounced by the user.

The portable device or system of the invention can be arranged in a small light-weight, e.g., plastic, casing and consists of a voice digitizer that converts short commands or answers pronounced by the user, e.g., into a binary-coded form. The output of the voice digitizer is connected to a central processing unit. The latter is also connected to a speech synthesizer and a random-number generator. A loudspeaker is connected to the output of the speech synthesizer. Other units available in the simple device of the invention are only a counter connected to the central processing unit, a USB port, a microphone connected to the voice digitizer, and a buffer memory between the central processing unit and the USB port. The central processing unit, voice digitizer, and speech synthesizer, etc. are energized by a powder supply, such as, e.g., 9V battery.

The device of the invention is used in the following manner. A buffer memory is loaded via the USB port with information preliminarily written, e.g. from the Internet or a compact disk onto a flash memory or a portable disk drive with a USB input. This information may contain, e.g., grouped sentences of multiple-choice examination questions. Each sentence of the group may be designated by a “one-word” index, e.g., “A”. “B”, “C”, “D”. The group may contain a plurality of sentences, but since the answer is pronounced after the user have listened all sentences of the group, it is not recommended to use more than four or five sentences in the group. Prior to the use, the user pronounces several commands or answers such as “A”. “B”, “C”, “D”, “repeat”, “wait”, “yes”, “no”, “next”, “back”, “explain”, that are recorded into a memory unit of the voice digitizer, converted into digitized codes, and sent to the central processing unit.

When the game is activated, controller or the random number generator selects from the pre-recorded information of the buffer memory a group of test sentences. The speech synthesizer converts these sentences into an audible form if needed. If the system does not include the random number generator, the use of which may be optional, the speech synthesizer will process sentences in sequence starting from the first one that is stored in the buffer memory unless the test was chosen by the controller. Each sentence is pronounced with its designation “A”, “B”, or “C”, etc. For example, the listener is asked a question, and then four choices of the answer are pronounced with their designations, and the listener should respond by pronouncing into the microphone only one of the indexes “A”, “B”, “C”, or “D” to confirm the answer that is in his/her opinion is correct. The pronounced response is digitized by the digitizer, compared with the corresponding digitized command stored in the memory of the voice digitizer, the selected digitized code of the index is sent to the central processing unit that compares it with the correct designation, and if the selected index coincides with the correct designation, the central processing unit sends the command to the counter that registers the correct answer as a score accumulated in the counter. If the answer has been received but is not correct, it is not added to the score. Thus, as the entire test is completed, the accumulated score shows the level of preparation to the exam and makes it possible to judge if the person passed or did not pass the test.

### BRIEF DESCRIPTION OF THE DRAWINGS

FIG. 1 is a general block diagram of the portable device or system of the invention.

FIGS. 2 and 3 are sequential parts of a flowchart of the system operation in accordance of the invention.

### DETAILED DESCRIPTION OF THE INVENTION

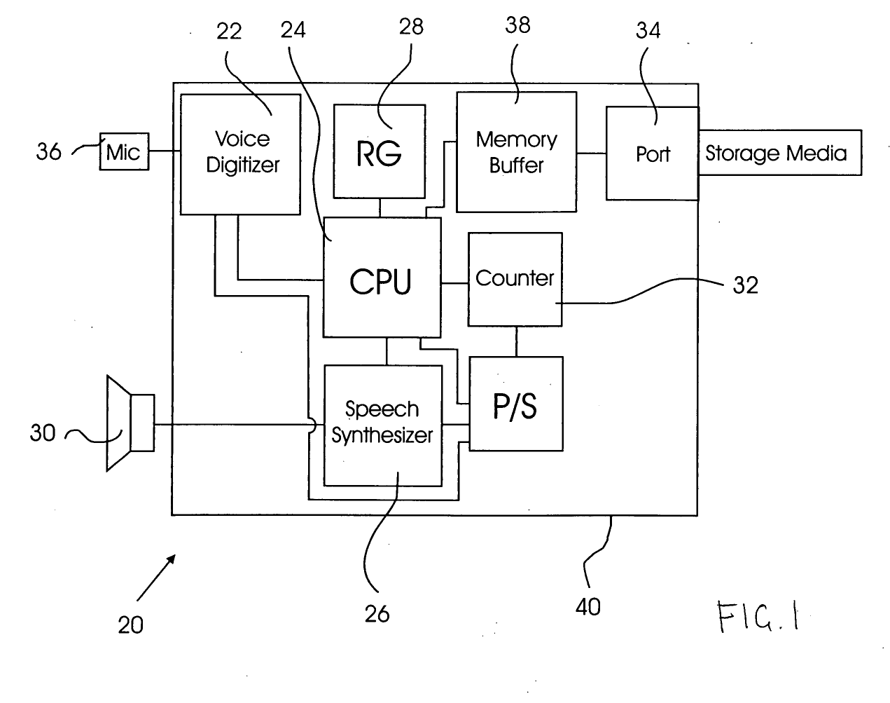

A general block diagram of the portable device or system of the invention, which as a whole is designated by reference numeral 20, is shown in FIG. 1. The main units of the system and their interconnection will now be described in general, and specific examples of separate units and their functions will be described later.

The system 20 consists of a voice digitizer 22 that is intended for conversion of short commands or answers pronounced by the user, e.g., into a binary-coded form. The output of the voice digitizer 22 is connected to a central processing unit 24. The latter is also connected to a speech synthesizer 26. If the system contains a random-number generator 28, the use of which is optional, the latter is connected to the central processing unit 24. In case the random-number generator 28 is absent, the game each time may be started from the beginning. A loudspeaker 30 is connected to the output of the speech synthesizer 22. Other units available in the system of the invention are only a counter 32 connected to the central processing unit, 24, a communication port, e.g., a USB port 34, or a slot for a storage medium, a microphone 36 connected to the voice digitizer 22, and a buffer memory 38 between the central processing unit 24 and the USB port 34. The system 20 shown in FIG. 1 can be designed so that it could be encased in a small portable or hand-held casing 40. The only items that are located externally of the casing 40 are the microphone 36, the loudspeaker 30, and optionally, the USB port or a slot for a storage medium.

The voice digitizer 22 is a commercially available device, e.g., Tiny-Voice, 20-pin single-chip controller described by Brad Stewart in “Circuit Cellar” computer applications journal, Issue 91, February 1998, pp. 12-17. This device is energized from a 9-V battery and can be trained to recognize up to 16 command templates. It costs less than $5. For embedded systems, Tiny Voice can be controlled over a parallel or serial protocol from a host microcontroller, or it can run stand-alone. The central processing unit, voice digitizer, and speech synthesizer, etc. are energized by a power supply 4, such as, e.g., 9V battery via a power switch P/S (FIG. 1).

The voice digitizer 22 of the aforementioned type can accept voice commands of one or several words, with a total maximum length of 1.6 s and a minimum of 0.2 s. Response time is typically <100 ms. By carefully selecting the vocabulary and context, over 95% recognition accuracy is possible. The heart of the Tiny-Voice is the 68HC705J1A Motorola 8-bit processor. There's sufficient RAM (64 bytes) to buffer the input waveforms and hold template structures, and its 1240 bytes of ROM provide enough program storage. Also, interrupts are supported, including changes on the I/O lines.

The central processing unit 24 may comprise a standard microprocessor, such as, e.g., 300 MHz Samsung S3C 2440 processor used in a pocket personal computer such as HP Pocket PC series with all the supporting circuitry.

The speech synthesizer 26 may be exemplified by a compact single-chip synthesizing CMOS VLSI IC type device with all supporting circuitry. This device is distributed by Jaztek Co., Taiwan.

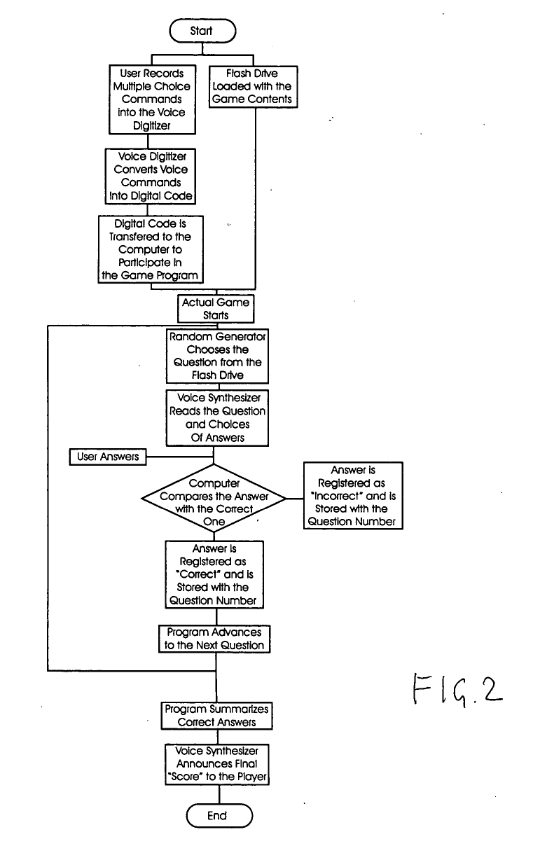

Operation of the system of the invention will now be described. The sequence of steps of the operation is shown in FIG. 2, which is a flowchart of the process. First, the buffer memory 38 is loaded via the USB port 34 with information preliminarily written, e.g. from the Internet or a compact disk onto a flash memory 35 or a portable disk drive (not shown) with a USB input. This information may contain, e.g., grouped sentences of multiple-choice questions. Each sentence of the group may be designated by a “one-word” or “one-letter” index, e.g., “A”. “B”, “C”, “D”, etc. The group may contain a plurality of sentences, but since the answer is pronounced after the user have listened all of the sentences of the group, it is not recommended to use more than four or five sentences in the group. Prior to the use, the user pronounces several commands or answers such as “A”. “B”, “C”, “D”, etc. that are recorded into a memory device of the voice digitizer 22, converted into digitized codes, and sent to the central processing unit 24.

When the game is activated by means of a power switch P/S (FIG. 1), the random number generator 28 selects from the pre-recorded information of the buffer memory 38 a group of test sentences. If the random number generator 28 is absent, the test sentences are taken in sequence directly from the buffer memory 38. The speech synthesizer 26 converts these sentences into an audible form, and the selected synthesized audible sentence is pronounced by the loudspeaker 30. Each sentence is pronounced with its designation “A”, “B”, or “C”, etc. For example, the listener is asked a question, and then four choices of the answer are pronounced with their designations, and the listener should respond by pronouncing into the microphone only one of the indexes “A”, “B”, “C”, etc. to confirm the answer that in his/her opening is correct. An example of such a group of questions e.g., for learning a foreign language, may be the following: The English equivalent for Japanese word “kotoba” is A—“letter”; B—“word”; C—“soup”; and D—“tea” ?. The correct answer corresponds to command “B” (the English for Japanese “kotoba” is “word”).

If the user pronounces an incorrect index, e.g., “A”, the pronounced response is digitized by the digitizer 22, compared with the corresponding digitized command stored in the memory of the voice digitizer 22, and the selected digitized code of the index is sent to the central processing unit 24 that compares it with the correct designation. In this case the selected index “A” does not coincide with the correct designation “B”, and the central processing unit 24 does not send the command to the counter 32 that in this case does not register the correct answer and does not increase the score of the counter 32.

If user pronounces a correct index “B”, the pronounced response is digitized by the digitizer 22, compared with the corresponding digitized command stored in the memory of the voice digitizer 22, and the selected digitized code of the index is sent to the central processing unit 24 that compares it with the correct designation. Since the selected index “B” coincides with the correct designation “B”, the central processing unit 24 sends the command to the counter 32 that in this case registers the correct answer and increases the score of the counter 32.

As the entire test is completed, the accumulated score shows the level of preparation to the exam and makes it possible to judge if the person passed or did not pass the test.

Another example may relate, e.g., to How smart are you? Test, such as given below:

1: Do they have a 4th of July in England?

A—Yes

B—No

2: How many birthdays does the average man have?

A—1

B—66

C—72

3: Some months have 31 days; how many have 28?

A—12

B—1

C—6

4: How many outs are there in an inning?

A—2

B—3

C—6

5: Is it legal for a man in California to marry his widow's sister?

A—Yes

B—No

Etc., total 11 questions

The central processing unit may have control buttons for adjusting the time allowed for the response. If the response has not been received during that time, the counter will not register the response, even if it is correct. For example, in the above-mentioned emotional test the time for the response may be limited by 5 min.

Thus, it has been shown that the invention provides a simple, light-weight, universal, and portable voice activated teaching aid and/or game that can be used by a person who for any reasons cannot distract his/her attention from a predetermined object, e.g., when fulfilling a long and monotonous work, or cannot use his/her vision or hands for any other reasons. The device can be loaded with an enormous volume of information via the flash memory or a portable disk drive but, at the same time, requires only a very small amount of machine-recognizable words or commands pronounced by the user.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, test of many other types can be used, such as IQ test, Introduction to SAT, GMAT, GRE, LSAT, MCAT, TOEFL (Test of English as a Second Language), Driver License Test, Health test, Career/job test Language test Personality test Think and Memory test, etc. The game may be, e.g., selection of geographical names from the 4-5 pronounced names with appropriate indexes with participation of two or more participants. Melodies from popular movies can be used instead of sentences. When two or more participants play the game simultaneously, the system may be taught to recognize separately the voice of each participant for each question of the group, or the participants can play the game one by one separately from the beginning to the end and then compare the score. The system may be equipped with a game selection features, or a sound signal for indication of a correction answer, etc. The game of the invention can be incorporated in a toy for teaching a child in an interactive mode.

1. A teaching aid and voice game system comprising:
a central processing unit;
a voice digitizer connected to a microphone and to said central processing unit;
a system input port;
a microphone connected to said voice digitizer;
a memory buffer connected to said system input port and to said central processing unit;
a speech synthesizer connected to the central processing unit;
a loudspeaker connected to said speed synthesizer; and
a counter connected to said central processing unit.

2. The teaching aid and voice game system of claim 1, further comprising a light-weight casing that contains said central processing unit, said voice digitizer, said system input port, said microphone, said memory buffer, said random number generator, said speech synthesizer, said loudspeaker, and said counter.

3. The teaching aid and voice game system of claim 1, wherein said system input port is a USB port.

4. The teaching aid and voice game system of claim 1, further comprising a random number generator connected to the central processing unit.

5. The teaching aid and voice game system of claim 4, wherein said system input port is a USB port.

6. The teaching aid and voice game system of claim 1, further comprising a power source and a power switch connected to said power switch.

7. The teaching aid and voice game system of claim 6, wherein said power source is connected via said power switch to said central processing unit, said speech synthesizer, said counter, and said voice digitizer.

8. The teaching aid and voice game system of claim 4, further comprising a power source and a power switch connected to said power switch.

9. The teaching aid and voice game system of claim 8, wherein said power source is connected via said power switch to said central processing unit, said speech synthesizer, said counter, and said voice digitizer.

10. The teaching aid and voice game system of claim 1, wherein said voice digitizer is a single-chip controller.

11. The teaching aid and voice game system of claim 1, wherein said central processing unit is a processor used in a pocket personal computer.

12. The teaching aid and voice game system of claim 1, wherein said speech synthesizer is a compact single-chip IC device with supporting circuitry.

13. The teaching aid and voice game system of claim 5, wherein said voice digitizer is a single-chip controller.

14. The teaching aid and voice game system of claim 5, wherein said central processing unit is a processor used in a pocket personal computer.

15. The teaching aid and voice game system of claim 5, wherein said speech synthesizer is a compact single-chip IC device with supporting circuitry.
